(19) United States
(12) Patent Application Publication
(10) Pub. No.: US 2026/0121729 A1
(43) Pub. Date: Apr. 30, 2026

(54) BEAM MAINTENANCE IN SIDELINK COMMUNICATION

(71) Applicant: TOYOTA JIDOSHA KABUSHIKI KAISHA, Toyota-shi, Aichi-ken (JP)

(72) Inventors: Takayuki SHIMIZU, Mountain View, CA (US); John KENNEY, Mountain View, CA (US); Hongsheng LU, Mountain View, CA (US); Onur ALTINTAS, Mountain View, CA (US); Chang-Yi LUO, Tokyo (JP); Nuno KIILERICH PRATAS, Gistrup (DK); Daniel MEDINA, Munchen (DE); Ling YU, Kauniainen (FI); Torsten WILDSCHEK, Gloucester (GB); Jan TUN, Glenview, IL (US)

(73) Assignee: TOYOTA JIDOSHA KABUSHIKI KAISHA, Toyota-shi, Aichi-ken (JP)

(21) Appl. No.: 19/116,720

(22) PCT Filed: Sep. 15, 2023
(86) PCT No.: PCT/JP2023/033713

§ 371 Date: Mar. 28, 2025

Related U.S. Application Data
(60) Provisional application No. 63/377,436, filed on Sep. 28, 2022.

(51) Int. Cl. H04B 7/06; H04W 28/02; H04W 72/044; H04W 72/40; H04W 76/25

(52) U.S. Cl. CPC H04B 7/06954; H04W 28/0226; H04W 72/046; H04W 72/40; H04W 76/25

(57) ABSTRACT

A first user equipment (UE) for sidelink beam maintenance in a sidelink communication. The first UE comprises-es a memory storing an instruction and a processor configured to execute the instruction stored in the memory to: obtain resource reservation information and future location information of the first UE, the future location information of the first UE including an estimated first location of the first UE at a first time later than a current time: transmit, to a second UE, the resource reservation information and the future location information of the first CE; receive, from the second UE, a signal including future location information of the second UE, the future location information of the second UE including an estimated second location of the second UE at the first time; and determine, based on the future location information of the second UE, one or more beams for transmission from the first CE.

### CROSS-REFERENCE TO RELATED PATENT APPLICATION

This application claims the benefit of U.S. Provisional Application No. 63/377,436, filed on Sep. 28, 2022, entitled “EXCHANGE OF FUTURE UE POSITION FOR SIDELINK BEAM TRACKING IN MILLIMETER-WAVE BANDS,” the entirety of which is incorporated by reference herein.

### TECHNICAL FIELD

Apparatuses and methods consistent with the present disclosure relate generally to communications, more specifically, methods, systems, and devices for sidelink beam maintenance in a sidelink communication.

### BACKGROUND ART

Sidelink communication technology enables direct communication between two or more devices, for example, two or more vehicles in a vehicle-to-everything (V2X) communication. A first vehicle in a sidelink communication may provide its resource reservation information to one or more other vehicles, for example, using a periodic broadcast of sidelink signal, so that other vehicles can avoid selecting the same resources for transmission. This scheme may work well for sidelink communications using low frequency bands (e.g., 5.9 GHZ or lower). But resource reservation and resource selection for sidelink communications using high frequency bands (e.g., mmWave bands) are more complicated. For high frequency radio signals, which suffer from high propagation loss, beamforming with narrow beams is generally used to compensate for the propagation loss. But beam alignment is challenging and changes over time, especially when the vehicles are moving. Improved systems and methods for beam maintenance for beam-based sidelink communications are desired.

### SUMMARY OF INVENTION

According to some embodiments of the present disclosure, there is provided a first user equipment (UE) for sidelink beam maintenance in a sidelink communication. The first UE includes a memory storing an instruction; and a processor configured to execute the instruction stored in the memory to: obtain resource reservation information and future location information of the first UE, the future location information of the first UE including an estimated first location of the first UE at a first time later than a current time; transmit, to a second UE, the resource reservation information and the future location information of the first UE; receive, from the second UE, a signal including future location information of the second UE, the future location information of the second UE including an estimated second location of the second UE at the first time; and determine, based on the future location information of the second UE, one or more beams for transmission from the first UE.

According to some embodiments of the present disclosure, there is provided a second UE for sidelink beam maintenance in a sidelink communication. The second UE includes a memory storing an instruction; and a processor configured to execute the instruction stored in the memory to: receive, from a first UE, resource reservation information and future location information of the first UE, the future location information of the first UE including an estimated first location of the first UE at a first time later than a current time; transmit, to the first UE, a signal in response to reception of the resource reservation information and the future location information of the first UE, the signal including future location information of the second UE, the future location information of the second UE including an estimated second location of the second UE at the first time; and determine, based on the future location information of the first UE, one or more beams for reception by the second UE.

According to some embodiments of the present disclosure, there is provided a method for sidelink beam maintenance in a sidelink communication. The method includes obtaining, by a first UE, resource reservation information and future location information of the first UE, the future location information of the first UE including an estimated first location of the first UE at a first time later than a current time; transmitting, to a second UE, the resource reservation information and the future location information of the first UE; receiving, from the second UE, a signal including future location information of the second UE, the future location information of the second UE including an estimated second location of the second UE at the first time; and determining, based on the future location information of the second UE, one or more beams for transmission from the first UE.

According to some embodiments of the present disclosure, there is provided a method for sidelink beam maintenance in a sidelink communication. The method includes receiving, by a second UE, from a first UE, resource reservation information and future location information of the first UE, the future location information of the first UE including an estimated first location of the first UE at a first time later than a current time; transmitting, to the first UE, a signal in response to reception of the resource reservation information and the future location information of the first UE, the signal including future location information of the second UE, the future location information of the second UE including an estimated second location of the second UE at the first time; and determining, based on the future location information of the first UE, one or more beams for reception by the second UE.

According to some embodiments of the present disclosure, there is provided a non-transitory computer-readable medium storing instructions that are executable by one or more processors of a first UE to perform a method. The method includes obtaining resource reservation information and future location information of the first UE, the future location information of the first UE including an estimated first location of the first UE at a first time later than a current time; transmitting, to a second UE, the resource reservation information and the future location information of the first UE; receiving, from the second UE, a signal including future location information of the second UE, the future location information of the second UE including an estimated second location of the second UE at the first time; and determining, based on the future location information of the second UE, one or more beams for transmission from the first UE.

According to some embodiments of the present disclosure, there is provided a non-transitory computer-readable medium storing instructions that are executable by one or more processors of a second UE to perform a method. The method includes receiving, from a first UE, resource reservation information and future location information of the first UE, the future location information of the first UE including an estimated first location of the first UE at a first time later than a current time; transmitting, to the first UE, a signal in response to reception of the resource reservation information and the future location information of the first UE, the signal including future location information of the second UE, the future location information of the second UE including an estimated second location of the second UE at the first time; and determining, based on the future location information of the first UE, one or more beams for reception by the second UE.

### BRIEF DESCRIPTION OF DRAWINGS

FIG. 1 is a flow chart illustrating a method for resource selection in a sidelink communication, consistent with some embodiments of the present disclosure.

FIG. 2A is a schematic diagram illustrating a resource candidate determination procedure according to the method of FIG. 1, consistent with some embodiments of the present disclosure.

FIG. 2B is a table showing a correspondence between sub-carrier spacing (SCS) and a subset of resources according to the method of FIG. 1, consistent with some embodiments of the present disclosure.

FIG. 3A is a schematic diagram illustrating a transmission of resource reservation information in a sidelink communication; and FIG. 3B is a schematic diagram illustrating a resource collision avoidance using the resource reservation information in the sidelink communication of FIG. 3A, consistent with some embodiments of the present disclosure.

FIG. 4 is a schematic diagram illustrating a sidelink beamforming in a communication system, consistent with some embodiments of the present disclosure.

FIG. 5A is a schematic diagram illustrating side information exchange in a low frequency sidelink communication; and FIG. 5B is a schematic diagram illustrating a side information assisted beam maintenance in the sidelink communication, consistent with some embodiments of the present disclosure.

FIG. 6 is a schematic diagram illustrating exchange of an estimated future location for beam maintenance in a beam-based sidelink communication, consistent with some embodiments of the present disclosure.

FIG. 7 is a schematic diagram illustrating a method for indicating an estimated future location of a UE, consistent with some embodiments of the present disclosure.

FIG. 8 is a schematic diagram illustrating an exemplary communication procedure in a sidelink communication, consistent with some embodiments of the present disclosure.

FIG. 9 is a flow chart illustrating a method for sidelink beam maintenance in a sidelink communication, consistent with some embodiments of the present disclosure.

FIG. 10 is a flow chart illustrating a method for sidelink beam maintenance in a sidelink communication, consistent with some embodiments of the present disclosure.

FIG. 11 is a block diagram of a UE, consistent with some embodiments of the present disclosure.

### DESCRIPTION OF EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of systems, apparatuses, and methods consistent with aspects related to the present disclosure as recited in the appended claims.

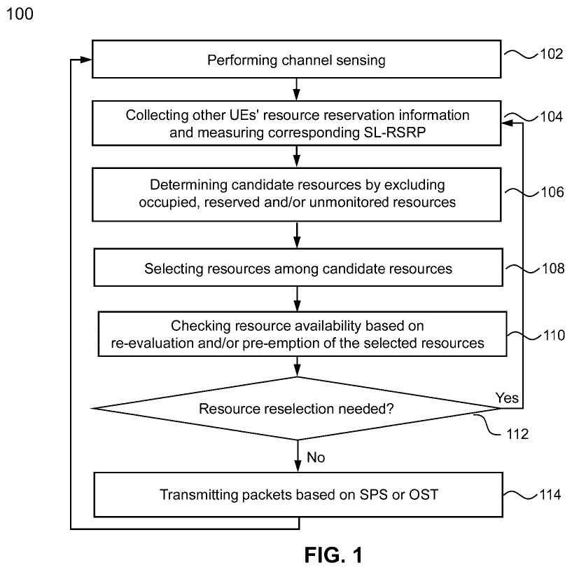

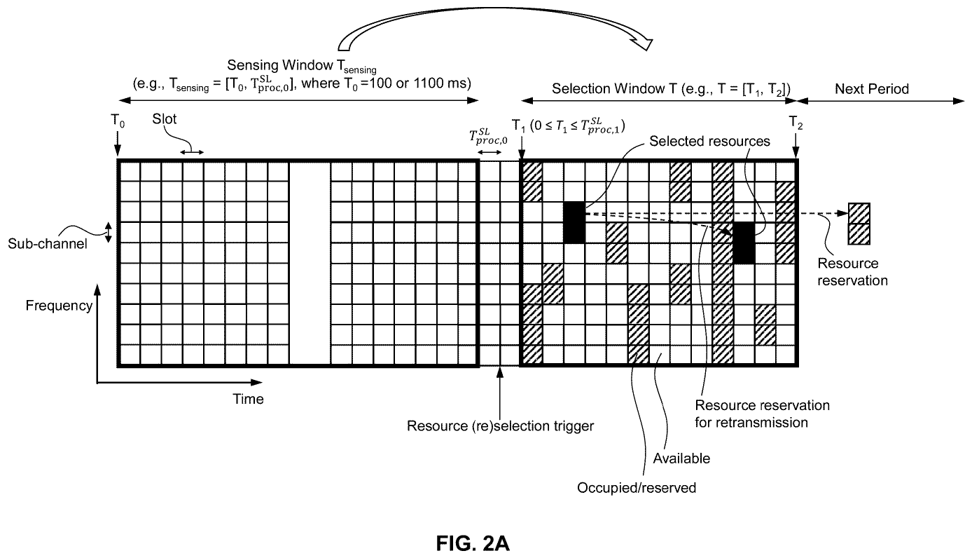

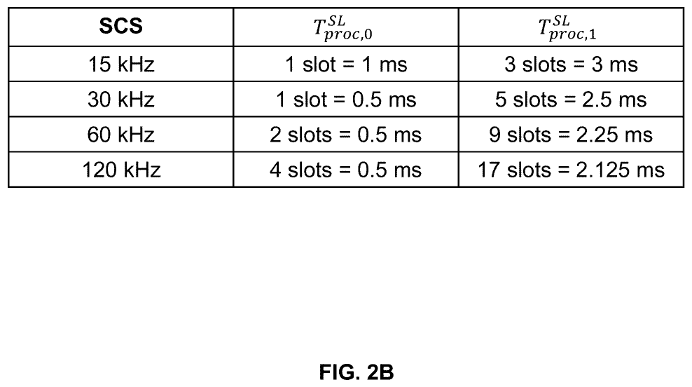

FIG. 1 is a flow chart illustrating a method 100 for resource selection in a sidelink communication; FIG. 2A is a schematic diagram illustrating a resource candidate determination procedure according to the method of FIG. 1; and FIG. 2B is a table showing a correspondence between SCS and a subset of resources according to the method of FIG. 1, consistent with some embodiments of the present disclosure. The method 100 may be performed by a UE in a sidelink communication. For example, the method 100 may be performed by a vehicle in a V2X communication. The method 100 may be performed under a mode that employs orthogonal frequency division multiplexing (OFDM) at the physical (PHY) layer for a sidelink communication. An example of the mode is the 3rd Generation Partnership Project (3GPP) Release 16/17 5G NR-V2X PC5 mode 2.

Referring to FIG. 2A, the time-frequency radio resources are divided into slots in the time domain and sub-channels in the frequency domain. In an embodiment, the mode may support SCSs of 15*2^{m} kHz, where m is the OFDM numerology m ∈ {0, 1, 2, 3, 4}. For sub-6 GHz frequency, SCSs of 15, 30, and 60 kHz (i.e., m ∈ {0, 1, 2}) may be supported, whereas for above 6 GHz frequency, SCSs of 60, 120, and 240 kHz (i.e., m ∈ {2, 3, 4}) may be supported. Each slot is ½^{m} ms length and consists of 14 OFDM symbols. Each sub-channel may consist of multiple contiguous physical resource blocks (PRBs), where each PRB occupies 180*2^{m} kHz and consists of 12 subcarriers with 15*2^{m} KHz SCS. The size of sub-channel (i.e., the number of PRBs per sub-channel) is configurable or preconfigurable. To support multiple SCSs and different Doppler spreads, multiple demodulation reference signal (DMRS) density options (2˜4 DMRS symbols per slot) can be used. Each UE may transmit a first stage sidelink control information (SCI) in the physical sidelink control channel (PSCCH) and data (e.g., transport block (TB)), and a second stage SCI in the physical sidelink shared channel (PSSCH). Hybrid automatic repeat request (HARQ) feedback (e.g., acknowledgement (ACK)/negative acknowledgement (NACK) or NACK only) may be transmitted in the physical sidelink feedback channel (PSFCH).

FIG. 2B shows the correspondence among SCS and parameters for the sensing window and selection window (T^{SL}_{proc,0} and T^{SL}_{proc,1}), consistent with some embodiments of the present disclosure. For example, when the SCS is 15 kHz, as shown in the second and third columns of FIG. 2B, T^{SL}_{proc,0} corresponds to 1 ms, and T^{SL}_{proc,1} correspond to 3 ms. As another example, when the SCS is 30 KHz, T^{SL}_{proc,0} corresponds to 0.5 ms, and T^{SL}_{proc,1} correspond 2.5 ms.

Referring back to FIG. 1, the method 100 includes a step 102 of performing a channel sensing (e.g., a background sensing or any other type of full sensing or partial sensing). For example, as shown in FIG. 2A, a UE may perform a channel sensing in a sensing window T_{sensing} (e.g., T_{sensing}=[T₀, T^{SL}_{proc,0}], where T₀=100 or 1100 ms and T^{SL}_{proc,0} is given in FIG. 2B) to collect one or more other UEs' resource reservation information. The channel sensing with a sensing window of 100 ms may be for an aperiodic traffic, while the channel sensing with a sensing window of 1100 ms may be for a periodic traffic.

The method 100 includes a step 104 of collecting one or more other UEs' resource reservation information and measuring corresponding sidelink-reference signal received power (SL-RSRP). For example, as shown in FIG. 2A, the UE may perform a channel sensing in the sensing window and collect one or more other UEs' resource reservation information based on SCI decoding to identify candidate resources. In an embodiment, in order to perform the channel sensing and obtain information to receive packets from other UEs, the UE performs SCI decoding first. The SCI decoding may include two stages: a first stage SCI (SCI format 1-A) and a second stage SCI (SCI format 2-A or 2-B) as defined in 3GPP specifications. The first stage SCI may carry resource reservation information for future transmissions, information about resource allocation, modulation and coding scheme (MCS) for PSSCH, DMRS pattern, and the second stage SCI format, etc. The second stage SCI may carry control information for HARQ procedures, source/destination identifications (IDs), information for distance-based groupcast (e.g., a UE's zone ID and communication range requirement), etc. Based on the resource reservation information contained in the first stage SCI, the UE may avoid using time and/or frequency resources reserved by other UEs when the UE performs resource selection or reselection.

The method 100 includes a step 106 of determining candidate resources by excluding occupied, reserved, and/or unmonitored resources. For example, the UE may exclude unmonitored slots from the selection window T (e.g., T=[T₁, T₂], where 0=<T₁=<T^{SL}_{proc,1} ms, T^{SL}_{proc,1} is given in FIG. 2B, and T₂ may be set based on the remaining packet delay budget). The UE may fail to sense the unmonitored slots in the sensing window due to, for example, its own transmission (e.g., half-duplex constraint). The UE may further exclude resources occupied or reserved by other UEs from the selection window if the corresponding SL-RSRP exceeds a configured or preconfigured SL-RSRP exclusion threshold. After resource exclusion, the number of candidate resources may be at least X % of the total number of resources in the selection window. Otherwise, the UE may increase the SL-RSRP exclusion threshold by, for example, 3 dB until at least X % resources are obtained, where X may be configured or preconfigured from {20, 35, 50} %.

The method 100 includes a step 108 of selecting resources among candidate resources. The selection may be a random selection. For example, as shown in FIG. 2A, the UE may select resources among candidate resources in the selection window. The selected frequency resource can be used multiple times with a fixed time interval for semi-persistent scheduling (SPS) or only once for one-shot transmission (OST).

In some embodiments, the method 100 may utilize an inter-UE coordination scheme in which one or more other UEs send coordination information about resources to the UE, and the UE utilizes that information for its resource selection or reselection. The inter-UE coordination scheme may include a first inter-UE coordination scheme and a second inter-UE coordination scheme. According to the first inter-UE coordination scheme, the UE may receive, from one or more other UEs, indications of resources that are preferred to be included in the UE's selected or reselected resources, or preferred to be excluded. In an embodiment, when an indication of resources indicates inclusion of given resources, the UE may solely rely on those resources, if the indication does not support sensing and/or resource exclusion. In an embodiment, the UE may also combine the indication of resources with resources identified by its own sensing procedure before making a final selection. The UE may receive the indication via medium access control (MAC) control element (CE) and/or 2nd-stage SCI. According to the second inter-UE coordination scheme, the UE may receive an indication that resources reserved for the UE's transmission will be, or could be, subject to conflict with a transmission from another UE. In this case, the UE may re-select new resources. The UE may receive the indication via PSFCH. The UE may use a mapping table that defines a mapping rule between PSSCH allocation (e.g., one or more slots and sub-channels) and PSFCH resources. Using the mapping table, the UE (and the transmitter UE) can determine the PSSCH allocation that the information in the PSFCH resource refers to. When more than one sub-channel is reserved in the PSSCH, multiple PSFCH resources may be used. The mapping table may be pre-defined, pre-configured at the UE, or configured by a network node.

The method 100 includes a step 110 of checking resource availability based on re-evaluation and/or pre-emption of the selected resources. This step may be performed for the late-arriving packets (e.g., aperiodic packets) after resource selection and before the packet transmission.

The method 100 includes a step 112 of determining whether a resource reselection is needed. If it is determined that a resource reselection is needed, the method may iterate from the step 104. On the other hand, if it is determined that a resource reselection is not needed, the method may proceed with a step 114 of transmitting packets based on SPS or OST. The packets may be initial packets or retransmitted packets. The UE may also retransmit packets multiple times (e.g., HARQ retransmissions) with or without feedback from receiver UE(s) to improve reliability of the transmission. After the step 114, the method 100 may iterate from step 102.

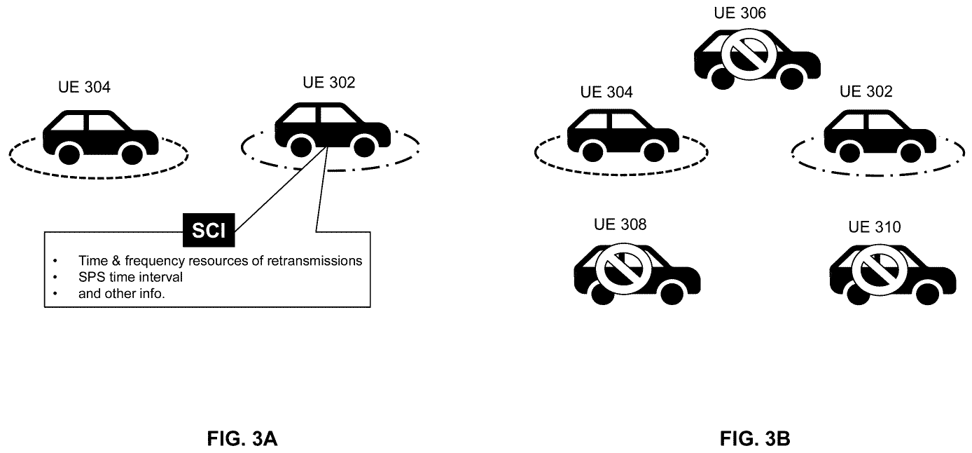

FIG. 3A is a schematic diagram illustrating a transmission of resource reservation information in a sidelink communication; and FIG. 3B is a schematic diagram illustrating a resource collision avoidance using the resource reservation information in the sidelink communication of FIG. 3A, consistent with some embodiments of the present disclosure. Referring to FIG. 3A and FIG. 3B, a sidelink communication system includes a UE 302, a UE 304, a UE 306, a UE 308, and a UE 310. For the sake of simplicity, FIG. 3A only shows the UE 302 and the UE 304. The UE 302 is a transmitter (Tx) UE (e.g., an omnidirectional Tx UE), and the UE 304 is a receiver (Rx) UE (e.g., an omnidirectional Rx UE) in the sidelink communication. The UE 302 may reserve resources for data transmission and encode the resource reservation information in SCI and transmit the SCI, for example, using one or more omnidirectional antennas. As shown in FIG. 3A, the SCI may include time and/or frequency resources for retransmissions scheduled at the UE 302, a SPS time interval, and other information. Other UEs (e.g., the UE 306, the UE 308, and the UE 310 of FIG. 3B) in the sidelink communication system may receive the SCI and decode the SCI to obtain the resource reservation information of the UE 302. Since other UEs obtain the time and/or frequency resources reserved by the UE 302, they may avoid using the same resources when they perform resource selection or reselection. In this way, resource collision may be avoided.

The resource reservation and resource selection scheme described above may be helpful for sidelink communications based on low frequency bands, for example, FR1 beam. In the present disclosure, FR1 is defined as a frequency range of from 410 to 7125 MHZ (including the sub-6 GHz spectrum). But the above noted scheme may not be applicable to sidelink communications based on high frequency bands (e.g., FR2). In the present disclosure, FR2 is defined as two frequency sub-ranges: FR2-1 from 24250 to 52600 MHZ and FR2-2 from 52600 to 71000 MHz (including the millimeter wave spectrum). For high frequency radio signals, which suffer from high propagation loss, beamforming with narrow beams is generally used to provide sufficient beamforming gain to compensate for the propagation loss. But beam alignment is challenging and changes over time, especially when the UEs are moving. Thus, beam tracking (or maintenance) may be helpful for sidelink communications based on high frequency bands (beam-based sidelink communications). The terms “beam tracking”, “beam maintenance”, and “beam management” are used interchangeably in this disclosure. At least some embodiments of the present disclosure provide methods for beam maintenance for beam-based sidelink communications.

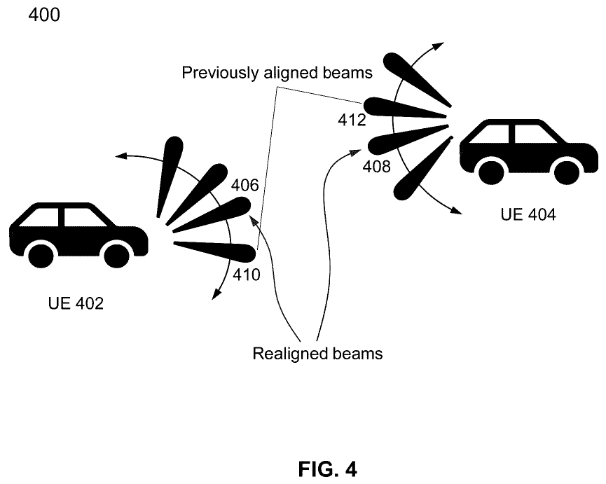

FIG. 4 is a schematic diagram illustrating beam maintenance for a beam-based sidelink communication, consistent with some embodiments of the present disclosure. Referring to FIG. 4, a communication system 400 includes a first UE (UE 402) and a second UE (UE 404) that communicate with each other via a sidelink communication using high frequency band signals (e.g., FR2). For example, the sidelink communication may be a V2X communication and both the UE 402 and the UE 404 are vehicles. The UE 402 may be a Tx UE and the UE 404 may be an Rx UE in the communication system 400. Since the sidelink communication between the UE 402 and the UE 404 uses high frequency signals, a sidelink beamforming is used so that a beam from the UE 402 and a beam from the UE 404 can be aligned. As shown in FIG. 4, a beam 410 from the UE 402 and a beam 412 from the UE 404 are a pair of beams that were previously aligned. But due to dynamic feature of the beam alignment in the system, the beam 410 from the UE 402 and the beam 412 are no longer aligned. Upon realignment, a beam 406 from the UE 402 and a beam 408 from the UE 404 are currently aligned. The terms “align”, “realign” and “beamforming” (and similar terms such as, e.g., aligned, alignment, realigned, and realignment) are used interchangeably in this disclosure.

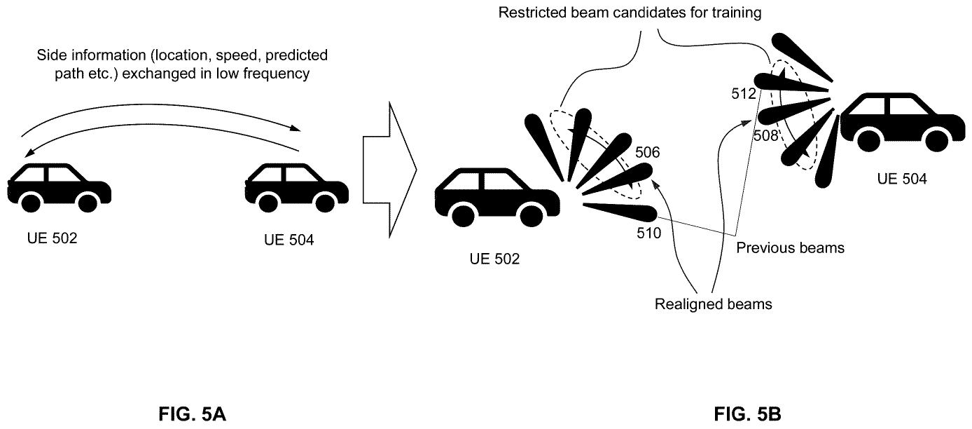

FIG. 5A is a schematic diagram illustrating a side information exchange in a low frequency sidelink communication; and FIG. 5B is a schematic diagram illustrating a side-information-assisted beam maintenance in the sidelink communication, consistent with some embodiments of the present disclosure. Referring to FIG. 5A and FIG. 5B, a communication system includes a UE 502 and a UE 504 that communicate with each other via sidelink communication. For example, the sidelink communication may be a V2X communication and both the UE 502 and the UE 504 are vehicles. The UE 502 may be a Tx UE and the UE 504 may be an Rx UE in the communication system. In some embodiments, as shown in FIG. 5A, the UE 502 and the UE 504 exchange side information using low frequency band signals (e.g., below 6 GHZ), for example, using omnidirectional antennas. The exchanged side information may include, for example, a current location, a speed, a predicted path of the UE 502 or the UE 504. The UE 502 and the UE 504 may exchange the side information periodically (e.g., every 100 ms). For example, the UE 502 and the UE 504 may exchange the side information by periodically broadcasting sidelink signals, such as European Telecommunications Standards Institute (ETSI) cooperative awareness messages (CAMs) or Society of Automotive Engineers (SAE) basic safety messages (BSMs).

Since the UE 502 and the UE 504 can detect their relative locations with each other by periodically exchanging BSM or CAM at a low frequency, they can also detect the change of their relative angles and adjust their beams accordingly. As shown in FIG. 5B, a beam 510 from the UE 502 and a beam 512 from the UE 504 are a pair of beams that were previously aligned, and a beam 506 from the UE 502 and a beam 508 from the UE 504 have been realigned after beam maintenance. In some embodiments, after the side information exchange, for beam-based sidelink communications, the UE 502 and the UE 504 may perform beam alignment using a restricted (small) number of candidate training pairs, for example, three beam pairs identified by the broken line ovals in FIG. 5B. The selected three beam pairs may cover a certain angular space instead of the whole angular space, depending on the position or angle estimation error. In some embodiments, using BSM or CAM, the UE 502 and the UE 504 may further share the information of predicted paths. A predicted (or estimated) path may be a path that the transmitting UE is expected to traverse in the form of radius of curvature. By exchanging the information of predicted paths, the UE 502 and the UE 504 can estimate the timing when they need to re-adjust their beams, and train a restricted number of beam candidates based on the information of predicted paths, so that they can further reduce the overhead of beam tracking. The UE 502 and the UE 504 may exchange the side information over at least one of PHY layer, MAC layer, or higher layer (network layer, transport layer, application layer, etc.).

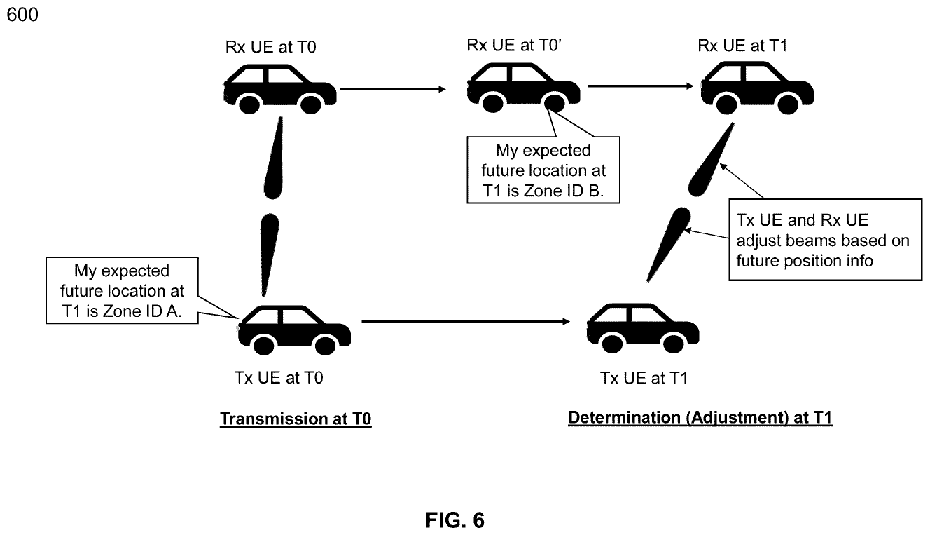

FIG. 6 is a schematic diagram illustrating exchange of an estimated future location for beam maintenance in a beam-based sidelink communication, consistent with some embodiments of the present disclosure. Referring to FIG. 6, a sidelink communication system 600 includes a Tx UE and an Rx UE that communicate with each other via a beam-based sidelink communication. The sidelink communication may be a V2X communication and both the Tx UE and the Rx UE are vehicles. The Tx UE and the Rx UE may exchange future location information (e.g., zone ID and sub-zone ID) at lower layers (e.g., PHY layer or MAC layer) for beam tracking and resource reservation. First, the Tx UE and the Rx UE may exchange their estimated future locations. A future location may be an estimated (e.g., expected) location at a time later than the current time. For example, as shown in FIG. 6, at T0, the Tx UE transmits a sidelink signal to the Rx UE indicating that an estimated future location of the Tx UE at T1 (a time later than TO) is Zone ID A. Upon receipt of the sidelink signal from the Tx UE, at T0′, the Rx UE may transmit a response signal (e.g., an acknowledgement) to the Tx UE indicating that an estimated future location of the Rx UE at T1 is Zone ID B. Next, during a time period that includes T₁ (e.g., either before, during, or after T₁), the Tx UE and the Rx UE respectively determine and possibly also adjust their Tx beam and Rx beam based on the exchanged future location information. After that, the Tx UE and the Rx UE may communicate using the determined (and possibly also adjusted) Tx beam and Rx beam. In this way, beam tracking (maintenance) with low signaling overhead for beam-based sidelink communication in mmWave bands may be achieved.

The procedure shown in FIG. 6 is merely one exemplary embodiment. The scope of the present disclosure is not so limited. In an embodiment, the determination and possible adjustment of the Tx beam at the Tx UE and the determination and possible adjustment of the Rx beam at the Rx UE may occur at different times. For example, the Tx UE may perform the determination and possible adjustment of the Tx beam in a first event, and the Rx UE may perform the determination and possible adjustment of Rx beam in a second event, in which the first event and the second event occur at two different points in time but are within a certain range of time. The range of time can be configured by a network node, or at the Tx UE and the Rx UE.

In an embodiment, the T0 and T0′ may be the same time. For example, the Rx UE may transmit a sidelink signal to the Tx UE indicating that an estimated future location of the Rx UE at T1 is Zone ID B, at the same time that the Tx UE transmits a sidelink signal to the Rx UE indicating that an estimated future location of the Tx UE at T1 is Zone ID A. In this embodiment, the sidelink signal transmitted from the Rx UE may be a spontaneous signal, rather than a response (or acknowledgement) to the sidelink signal received from the Tx UE. In another embodiment, T0′ may be earlier than T0 (i.e., the Rx UE may transmit its sidelink signal before Tx UE transmits its sidelink signal).

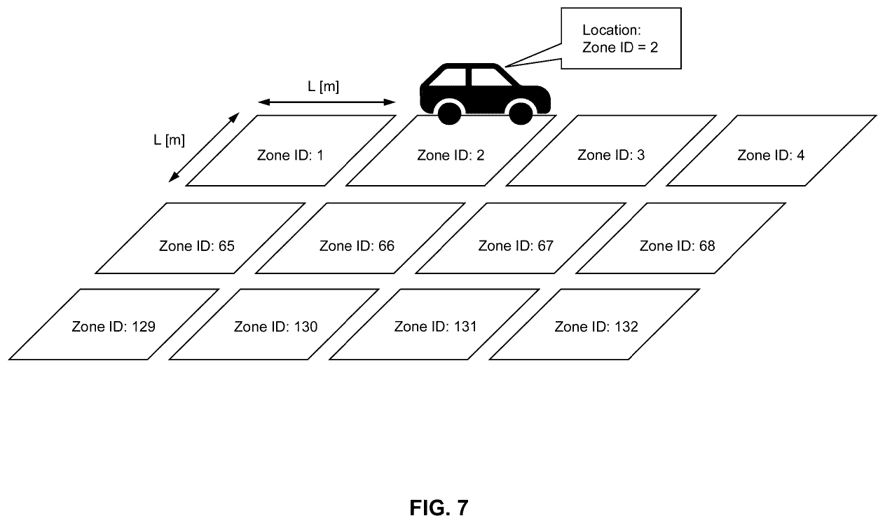

FIG. 7 is a schematic diagram illustrating a method for indicating an estimated future location of a UE, consistent with some embodiments of the present disclosure. In some embodiments, as shown in FIG. 7, multiple two-dimensional (2D) zones are configured. Each zone has a unique identification (ID) number (e.g., 1, 2, 3, 4, . . . , 132). For example, a zone having ID of 1 is configured. Each dimension (e.g., width and length) L of the zones is also configured, for example, from 1, 5, 10, 20, 30, 40, 50 m (e.g., when each zone is 2-dimensional (2D) and has a substantially square shaped). The zone dimension L can be any other number, for example, smaller than 1 m or larger than 50m. In this way, an estimated future location of a UE is indicated using an ID of a zone at which the UE is expected to be located. In some embodiments, instead of the 2D zone, a 3D zone corresponding to 3D beamforming (i.e., horizontal and vertical beamforming) is also configured.

In some embodiments, a finer sub-zone which corresponds to a zone within the legacy zone is used for beam management, thereby increasing resolution of location indication. For example, the legacy zone ID may be used to determine the left-most upper position of the zone, while the finer (new) zone ID may be used to identify the sub-zone for beamforming purposes.

In an embodiment, for example, the sub-zone may be determined as follows:

$$x 1 = Floor ( x ) Mod L ;$$

$$y 1 = Floor ( y ) Mod L ;$$

$$Sub - Zone\_id = y 1 * L + x 1.$$

Where L is the above-mentioned zone dimension included in sidelink zone configuration (sl-ZoneConfig); x is the geodesic distance in longitude between UE's current location and geographical coordinates (0, 0) according to WGS84 model and it is expressed in meters; y is the geodesic distance in latitude between UE's current location and geographical coordinates (0, 0) according to WGS84 model and it is expressed in meters.

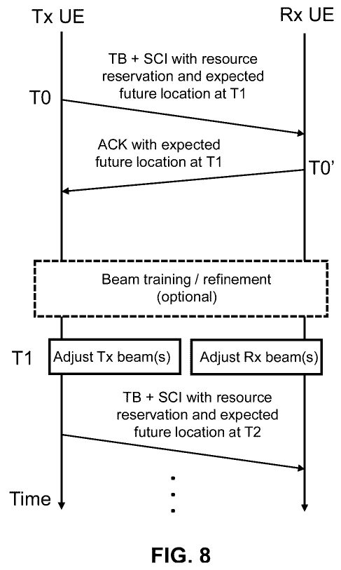

FIG. 8 is a schematic diagram illustrating an exemplary communication procedure in a sidelink communication, consistent with some embodiments of the present disclosure. Referring to FIG. 8, the procedure includes the following steps. Initially, at time T0, a Tx UE may transmit one or more packets to an Rx UE. The one or more packets may include one or more TBs and SCI. The SCI includes an estimated future location (e.g., zone ID and sub-zone ID) of the Tx UE at T1 (a time later than TO). The estimated future location may be carried as at least one of SCI at PHY layer, MAC CE at MAC layer, or higher layer information (for example, using the radio resource control (RRC) protocol). The SCI may also include resource reservation for HARQ packets and/or next TB packet(s) to be transmitted at T₁. In some embodiments, the Tx UE may transmit the one or more packets and the SCI separately. In some embodiments, the Tx UE may only transmit the SCI.

Then, at time T0′ (T0′ is a time later than T0 but earlier than T1), after the Rx UE receives the one or more packets and/or the SCI from the Tx UE, the Rx UE transmits a signal (e.g., ACK). The signal may include an estimated future location (e.g., zone ID and sub-zone ID) of the Rx UE at T1. The estimated future location of the Rx UE may be carried by at least one of SCI at PHY later, MAC CE at MAC layer, or higher layer information (for example, using the RRC protocol).

In an embodiment, the T0 and T0′ are the same time. For example, the Rx UE may transmit a sidelink signal to the Tx UE indicating that an estimated future location of the Rx UE at T1 is Zone ID B, at the same time that the Tx UE transmits a sidelink signal to the Rx UE indicating that an estimated future location of the Tx UE at T1 is Zone ID A. In this embodiment, the sidelink signal transmitted from the Rx UE is a spontaneous signal, rather than a response (or acknowledgement) to the sidelink signal received from the Tx UE indicating that an estimated future location of the Rx UE at T1 is Zone ID B. In another embodiment, T0′ may be earlier than T0 (i.e., the Rx UE may transmit its sidelink signal before Tx UE transmits its sidelink signal).

After T0′, the Tx UE may perform beam training and/or refinement on one or more beams of a plurality of candidate Tx beams. Similarly, the Rx UE may also perform beam training and/or refinement on one or more beams of a plurality of candidate Rx beams. In some embodiments, the Tx UE and the Rx UE perform the beam training and/or refinement simultaneously. In some embodiments, the Tx UE and the Rx UE perform beam training and/or refinement at different times. In some embodiments, both the Tx UE and the Rx UE omit the beam training and/or refinement. In some embodiments, only one of the Tx UE and the Rx UE performs the beam training and/or refinement.

During a time period that includes T1 (e.g., either before, during, or after T1), the Tx UE determines (and possibly also adjusts), based on the future location information of the Rx UE at T1, one or more Tx beams for transmission from the Tx UE. Also, during the time period that includes T1, the Rx UE determines (and possibly also adjusts), based on the future location information of the Tx UE at T1, one or more Rx beams for reception by the Rx UE. In an embodiment, the Tx UE and the Rx UE perform the determination (and possible adjustment) of the respective one or more Tx beams and one or more Rx beams simultaneously. In another embodiment, the Tx UE and the Rx UE may perform the determination (and possible adjustment) of the respective one or more Tx beams and one or more Rx beams at different times. For example, the Tx UE may perform the determination (and possible adjustment) of the Tx beam in a first event, and the Rx UE may perform the determination (and possible adjustment) of Rx beam in a second event, in which the first event and the second event are different points in time but are within a certain duration of time. The duration of time can be configured by a network node, or at the Tx UE and/or the Rx UE.

Thereafter, the Tx UE may transmit one or more packets to the Rx UE. The one or more packets may include SCI that includes an estimated future location information of the Tx UE at T2 (T2 is a time later than T1). The SCI may also include resource reservations information. The above-noted steps may then be repeated. In some embodiments, the Tx UE may omit the transmission after the beam determination (and possible adjustment) and the process is iterated from the beginning (at TO). In some embodiments, the Tx UE may transmit the one or more packets and the SCI separately. In some embodiments, the Tx UE may only transmit the SCI.

In some embodiments, the expected future location of a UE may be calculated using a simple estimation technique based on a current position, a speed, and a heading of the UE, assuming that the speed and heading are constant. In some embodiments, the expected future location of a UE may be calculated using more advanced estimation techniques considering vehicle dynamics. The future location information may be indicated by SCI in FR1 bands (e.g., 5.9 GHz) and/or FR2 mmWave bands. In some embodiments, the zone dimension L (as shown in FIG. 7) is small enough (e.g., 1 m or less) so that location information is useful for beam management.

The methods described in this disclosure can be applied to any sidelink communications, for example, long term evolution (LTE) or new radio (NR) or a future generation (6th generation (6G), 7th generation (7G), or any future generation) sidelink communications. The methods described in this disclosure can also be applied to downlink/uplink communications between a base station and a UE. The methods described in this disclosure can also be applied to other systems, for example, the systems that comply with other standards (e.g., the Institute of Electrical and Electronics Engineers (IEEE) standards).

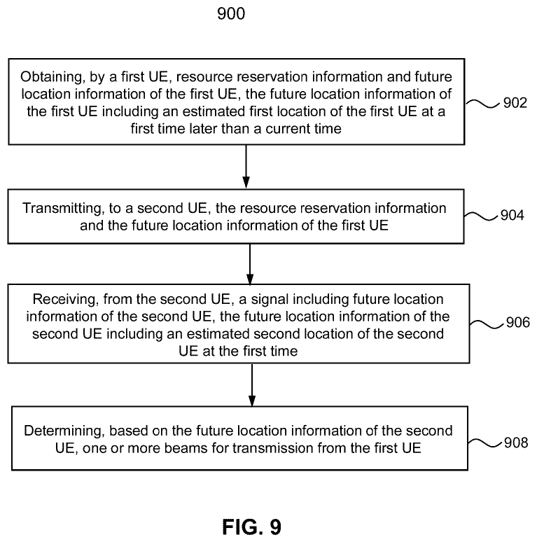

FIG. 9 is a flow chart illustrating a method 900 for sidelink beam maintenance in a sidelink communication, consistent with some embodiments of the present disclosure. The method 900 may be performed by a Tx UE in a sidelink communication, such as the Tx UE of FIGS. 6 and 8.

The method 900 includes a step 902 of obtaining, by a first UE, resource reservation information and future location information of the first UE, the future location information of the first UE including an estimated first location of the first UE at a first time later than a current time. In some embodiments, the first UE determines the estimated first location of the first UE at the first time based on at least one of: a current location of the first UE, a speed of the first UE, a heading of the first UE, or a planned trajectory of the first UE.

The method 900 includes a step 904 of transmitting, to a second UE, the resource reservation information and the future location information of the first UE. In some embodiments, the first UE may transmit the resource reservation information and the future location information of the first UE using a low frequency band (e.g., FR1). In some embodiments, the first UE may transmit the resource reservation information and the future location information of the first UE using a high frequency band (e.g., FR2 or millimeter wave frequency band).

In some embodiments, the resource reservation information and the future location information of the first UE may be transmitted via at least one of SCI at PHY layer, MAC CE at MAC layer, or higher layer information. The higher layer may be a network layer, a transport layer, or an application layer. The higher layer may make use of the RRC protocol.

In some embodiments, the resource reservation information and the future location information of the first UE are included in a packet transmitted from the first UE to the second UE.

In some embodiments, the future location information of the first UE is indicated as an ID of a zone of a plurality of zones in two-dimension or three-dimension. The plurality of zones may be configured by a network node or pre-configured at the first UE. In some embodiments, the future location information of the first UE is indicated as two or more IDs of a zone of a plurality of zones in two-dimension or three-dimension, the two or more IDs of the zone including a sub-zone ID that is used for beamforming. The plurality of zones may be configured by a network node or pre-configured at the first UE.

The method 900 includes a step 906 of receiving, from the second UE, a signal including future location information of the second UE, the future location information of the second UE including an estimated second location of the second UE at the first time. In some embodiment, the signal received from the second UE may include a HARQ acknowledgement message. In some embodiments, the future location information of the second UE is transmitted via at least one of SCI at PHY layer, MAC CE at MAC layer, or higher layer information. The higher layer may make use of the RRC protocol.

In some embodiments, the future location information of the second UE is indicated as an ID of a zone of a plurality of zones in two-dimension or three-dimension. The plurality of zones may be configured by a network node or pre-configured at the first UE. In some embodiments, the future location information of the second UE is indicated as two or more IDs of a zone of a plurality of zones in two-dimension or three-dimension, the two or more IDs of the zone including a sub-zone ID that is used for beamforming, the plurality of zones being configured or pre-configured.

The method 900 includes a step 908 of determining, based on the future location information of the second UE, one or more beams for transmission from the first UE. In some embodiments, the first UE may perform beam training on one or more beams of a plurality of beams before determining the one or more beams. In some embodiments, the first UE may determine the beam for transmission based on a trigger signal received via a sidelink transmission. In some embodiments, the method 900 may further include at least one of the first UE transmitting to the second UE using the determined one or more beams, or the first UE iterating the method 900 from the step 902. In some embodiments, the first UE may determine the one or more beams for transmission from the first UE within a time period, the time period including the first time. For example, the time period may extend from the step 906 to at least one of the first UE transmitting to the second UE using the determined one or more beams, or the first UE iterating the method 900 from the step 902.

In some embodiments, the future location information of the first UE is a first future location information of the first UE and the first UE may further transmit, to the second UE, a packet using the determined one or more beams. The packet may include second future location information of the first UE. The second future location information of the first UE may include an estimated third location of the first UE at a second time later than the first time. The estimated third location being the same as, or different from, the estimated first location or the estimated second location. And the steps of the method 900 can be continued by iterating the method 900 from step 902.

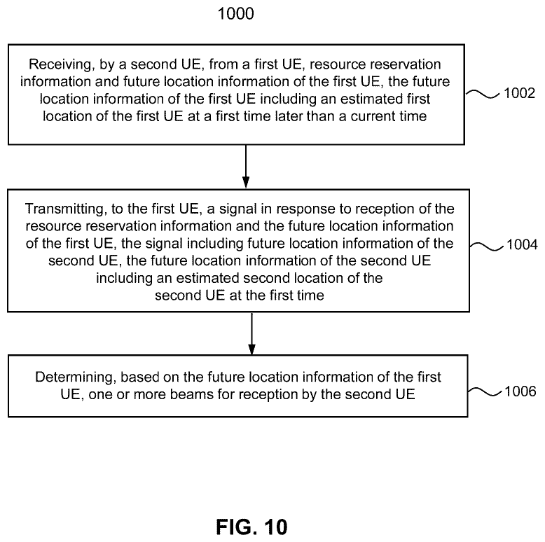

FIG. 10 is a flow chart illustrating a method 1000 for sidelink beam maintenance in a sidelink communication, consistent with some embodiments of the present disclosure. The method 1000 may be performed by an Rx UE in a sidelink communication, such as the Rx UE of FIGS. 6 and 8.

The method 1000 includes a step 1002 of receiving, by a second UE, from a first UE, resource reservation information and future location information of the first UE, the future location information of the first UE including an estimated first location of the first UE at a first time later than a current time. In some embodiments, the resource reservation information and the future location information of the first UE may be included in a packet transmitted from the first UE to the second UE.

In some embodiments, the future location information of the first UE may be indicated as an ID of a zone of a plurality of zones in two-dimension or three-dimension. The plurality of zones may be configured by a network node or pre-configured at the first UE. In some embodiments, the future location information of the first UE is indicated as two or more IDs of a zone of a plurality of zones in two-dimension or three-dimension, the two or more IDs of the zone including a sub-zone ID that is used for beamforming. The plurality of zones may be configured by a network node or pre-configured at the first UE.

The method 1000 includes a step 1004 of transmitting, to the first UE, a signal in response to reception of the resource reservation information and the future location information of the first UE, the signal including future location information of the second UE, the future location information of the second UE including an estimated second location of the second UE at the first time. The second UE may determine the estimated second location of the second UE at the first time based on at least one of: a current location of the second UE, a speed of the second UE, a heading of the second UE, or a planned trajectory of the second UE. In some embodiments, the signal transmitted to the first UE may include a HARQ acknowledgement message.

In some embodiments, the future location information of the second UE is transmitted via at least one of SCI at PHY layer, MAC CE at MAC layer, or higher layer information. The higher layer may make use of the RRC protocol. In some embodiments, the future location information of the second UE is transmitted using a low frequency band (e.g., FR1). In some embodiments, the future location information of the second UE is transmitted using a high frequency band (e.g., millimeter wave frequency band).

In some embodiments, the future location information of the second UE is indicated as an ID of a zone of a plurality of zones in two-dimension or three-dimension. The plurality of zones may be configured or pre-configured. In some embodiments, the future location information of the second UE is indicated as two or more IDs of a zone of a plurality of zones in two-dimension or three-dimension, the two or more IDs of the zone including a sub-zone ID that is used for beamforming. The plurality of zones may be configured or pre-configured.

The method 1000 includes a step 1006 of determining, based on the future location information of the first UE, one or more beams for reception by the second UE. In some embodiments, the method 900 may further include at least one of the second UE receiving from the first UE the determined one or more beams, or the second UE iterating the method 1000 from the step 1002. In some embodiments, the second UE may determine the one or more beams for reception by the second UE within a time period, the time period including the first time. For example, the time period may extend from the step 1004 to at least one of the second UE receiving from the first UE the determined one or more beams, or the second UE iterating the method 1000 from the step 1002. In some embodiments, the second UE may perform beam training on one or more beams of a plurality of beams before determining the one or more beams.

In some embodiments, the second UE may receive, from the first UE, a packet using the determined one or more beams. In some embodiments, the future location information of the first UE is a first future location information of the first UE, and the packet may include second future location information of the first UE. The second future location information of the first UE may include an estimated third location of the first UE at a second time later than the first time. The estimated third location may be the same as, or different from, the estimated first location or the estimated second location. And the steps of the method 1000 may be continued by iterating the method from step 1002.

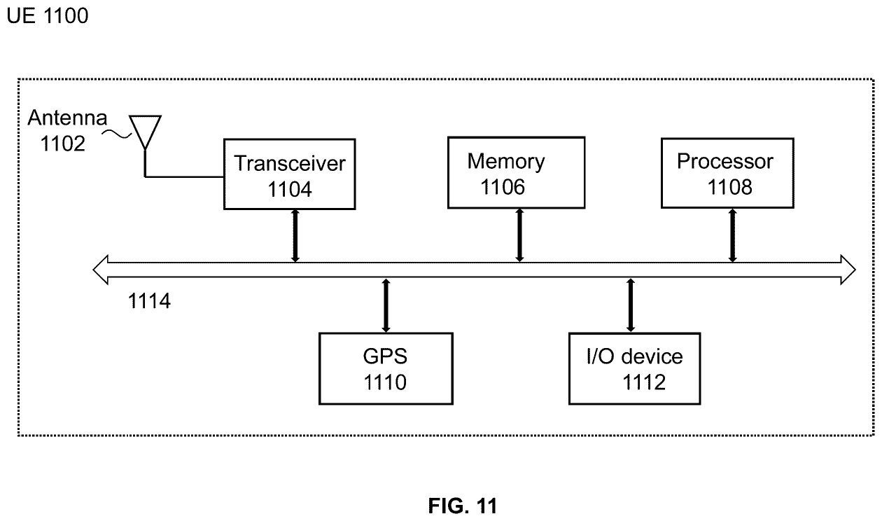

FIG. 11 is a block diagram of a UE 1100, consistent with some embodiments of the present disclosure. For example, each of the Tx UE and the Rx UE in FIGS. 6 and 8 may be in the form of UE 1100. UE 1100 may be mounted in a moving vehicle or in a fixed position. UE 1100 may take any form, including but not limited to, a vehicle, a component mounted in a vehicle, a road-side unit, a laptop computer, a wireless terminal including a mobile phone, a wireless handheld device, or wireless personal device, or any other form. Referring to FIG. 11, the UE 1100 may include antenna 1102 that may be used for transmission or reception of electromagnetic signals to/from a base station or other UEs. The Antenna 1102 may include one or more antenna elements and may enable different input-output antenna configurations, for example, multiple input multiple output (MIMO) configuration, multiple input single output (MISO) configuration, and single input multiple output (SIMO) configuration. In some embodiments, the antenna 1102 may include multiple (e.g., tens or hundreds) antenna elements and may enable multi-antenna functions such as beamforming. In some embodiments, the antenna 1102 is a single antenna. The antenna 1102 can be an FR1 antenna or an FR2 antenna.

The UE 1100 may include a transceiver 1104 that is coupled to the antenna 1102. The transceiver 1104 may be a wireless transceiver at the UE 1100 and may communicate bi-directionally with a base station or other UEs. For example, the transceiver 1104 may receive/transmit wireless signals from/to a base station via downlink/uplink communication. The transceiver 1104 may also receive/transmit wireless signals from/to another UE or road side unit via sidelink communication. The transceiver 1104 may include a modem to modulate the packets and provide the modulated packets to the antenna 1102 for transmission, and to demodulate packets received from the antenna 1102.

The UE 1100 may include a memory 1106. The memory 1106 may be any type of computer-readable storage medium including volatile or non-volatile memory devices, or a combination thereof. The computer-readable storage medium includes, but is not limited to, non-transitory computer storage media. A non-transitory storage medium may be accessed by a general purpose or special purpose computer. Examples of non-transitory storage medium include, but are not limited to, a portable computer diskette, a hard disk, random access memory (RAM), read-only memory (ROM), an erasable programmable read-only memory (EPROM), electrically erasable programmable ROM (EEPROM), a digital versatile disk (DVD), flash memory, compact disk (CD) ROM or other optical disk storage, magnetic disk storage or other magnetic storage devices, etc. A non-transitory medium may be used to carry or store desired program code means (e.g., instructions and/or data structures) and may be accessed by a general-purpose or special-purpose computer, or a general-purpose or special-purpose processor. In some examples, the software/program code may be transmitted from a remote source (e.g., a website, a server, etc.) using a coaxial cable, fiber optic cable, twisted pair, digital subscriber line (DSL), or wireless technologies such as infrared, radio, and microwave. In such examples, the coaxial cable, fiber optic cable, twisted pair, DSL, or wireless technologies such as infrared, radio, and microwave are within the scope of the definition of medium. Combinations of the above examples are also within the scope of computer-readable medium.

The memory 1106 may store information related to identities of UE 1100 and the signals and/or data received by antenna 1102. The memory 1106 may also store post-processing signals and/or data. The memory 1106 may also store computer-readable program instructions, mathematical models, and algorithms that are used in signal processing in receiver 1104 and computations in processor 1108. The memory 1106 may further store computer-readable program instructions for execution by processor 1108 to operate UE 1100 to perform various functions described in this disclosure. In some examples, the memory 1106 may include a basic input/output system (BIOS) which may control basic hardware or software operation such as the interaction with peripheral components or devices. In some embodiments, the memory 1106 includes both LTE SL and NR SL modules. In some embodiments, the memory 1106 includes an NR SL module only.

In some embodiments, the memory 1106 includes an LTE SL module only.

The computer-readable program instructions of the present disclosure may be assembler instructions, instruction-set-architecture (ISA) instructions, machine instructions, machine-dependent instructions, microcode, firmware instructions, state-setting data, or source code or object code written in any combination of one or more programming languages, including an object-oriented programming language, and conventional procedural programming languages. The computer-readable program instructions may execute entirely on a computing device as a stand-alone software package, or partly on a first computing device and partly on a second computing device remote from the first computing device. In the latter scenario, the second, remote computing device may be connected to the first computing device through any type of network, including a local area network (LAN) or a wide area network (WAN).

The UE 1100 may include a processor 1108 that may include a hardware device with processing capabilities. The processor 1108 may include at least one of a general-purpose processor, a digital signal processor (DSP), a central processing unit (CPU), a microcontroller, an application specific integrated circuit (ASIC), a field programmable gate array (FPGA), a programmable logic device, a discrete gate or transistor logic component, a discrete hardware component, or other programmable logic device. Examples of the general-purpose processor include, but are not limited to, a microprocessor, any conventional processor, a controller, a microcontroller, or a state machine. In some embodiments, the processor 1108 may be implemented using a combination of devices (e.g., a combination of a DSP and a microprocessor, multiple microprocessors, one or more microprocessors in conjunction with a DSP core, or any other such configuration). The processor 1108 may receive, from transceiver 1104, downlink signals or sidelink signals and further process the signals. The processor 1108 may also receive, from transceiver 1104, data packets and further process the packets. In some embodiments, the processor 1108 may be configured to operate a memory using a memory controller. In some embodiments, a memory controller may be integrated into the processor 1108. The processor 1108 may be configured to execute computer-readable instructions stored in a memory (e.g., the memory 1106) to cause the UE 1100 to perform various functions.

The UE 1100 may include a global positioning system (GPS) 1110. The GPS 1110 may be used for enabling location-based services or other services based on a geographical position of the UE 1100 and/or synchronization among UEs. The GPS 1110 may receive global navigation satellite systems (GNSS) signals from a single satellite or a plurality of satellite signals via the antenna 1102 and provide a geographical position of the UE 1100 (e.g., coordinates of the UE 1100). In some embodiments, the GPS 1110 is omitted. In some embodiments, a timer is included.

The UE 1100 may include an input/output (I/O) device 1112 that may be used to communicate a result of signal processing and computation to a user or another device. The I/O device 1112 may include a user interface including a display and an input device to transmit a user command to processor 1108. The display may be configured to display a status of signal reception at the UE 1100, the data stored at memory 1106, a status of signal processing, and a result of computation, etc. The display may include, but is not limited to, a cathode ray tube (CRT), a liquid crystal display (LCD), a light-emitting diode (LED), a gas plasma display, a touch screen, or other image projection devices for displaying information to a user. The input device may be any type of computer hardware equipment used to receive data and control signals from a user. The input device may include, but is not limited to, a keyboard, a mouse, a scanner, a digital camera, a joystick, a trackball, cursor direction keys, a touchscreen monitor, or audio/video commanders, etc.

The UE 1100 may further include a machine interface 1114, such as an electrical bus that connects the transceiver 1104, the memory 1106, the processor 1108, the GPS 1110, and the I/O device 1112.

In some embodiments, the UE 1100 may be a transmitter UE (e.g., a first UE) in a sidelink communication (e.g., the Tx UE of FIGS. 6 and 8) and configured or programmed to perform sidelink beam maintenance in the sidelink communication. The processor 1108 may be configured or programmed to execute the instructions stored in the memory 1106 to obtain resource reservation information and future location information of the first UE, the future location information of the first UE including an estimated first location of the first UE at a first time later than a current time; transmit, to a second UE, the resource reservation information and the future location information of the first UE; receive, from the second UE, a signal including future location information of the second UE, the future location information of the second UE including an estimated second location of the second UE at the first time; and determine, based on the future location information of the second UE, one or more beams for transmission from the first UE.

In some embodiments, the UE 1100 may be a receiver UE (e.g., a second UE) in a sidelink communication (e.g., the Rx UE of FIGS. 6 and 8) and configured or programmed to perform sidelink beam maintenance in the sidelink communication. The processor 1108 may be configured or programmed to execute the instructions stored in the memory 1106 to receive, from a first UE, resource reservation information and future location information of the first UE, the future location information of the first UE including an estimated first location of the first UE at a first time later than a current time; transmit, to the first UE, a signal in response to reception of the resource reservation information and the future location information of the first UE, the signal including future location information of the second UE, the future location information of the second UE including an estimated second location of the second UE at the first time; and determine, based on the future location information of the first UE, one or more beams for reception by the second UE.

As used in this disclosure, use of the term “or” in a list of items indicates an inclusive list. The list of items may be prefaced by a phrase such as “at least one of” or “one or more of.” For example, a list of at least one of A, B, or C includes A or B or C or AB (i.e., A and B) or AC or BC or ABC (i.e., A and B and C). Also, as used in this disclosure, prefacing a list of conditions with the phrase “based on” shall not be construed as “based only on” the set of conditions and rather shall be construed as “based at least in part on” the set of conditions. For example, an outcome described as “based on condition A” may be based on both a condition A and a condition B without departing from the scope of this disclosure.

In this specification, the terms “comprise,” “include,” or “contain” may be used interchangeably and have the same meaning and are to be construed as inclusive and open-ended. The terms “comprise,” “include,” or “contain” may be used before a list of elements and indicate that at least all of the listed elements within the list exist but other elements that are not in the list may also be present. For example, if A comprises B and C, both {B, C} and {B, C, D} are within the scope of A.

The present disclosure, in connection with the accompanied drawings, describes example configurations that are not representative of all the examples that may be implemented or all configurations that are within the scope of this disclosure. The term “exemplary” should not be construed as “preferred” or “advantageous compared to other examples” but rather “an illustration, an instance or an example.” By reading this disclosure, including the description of the embodiments and the drawings, it will be appreciated by a person of ordinary skills in the art that the technology disclosed herein may be implemented using alternative embodiments. The person of ordinary skill in the art would appreciate that the embodiments, or certain features of the embodiments described herein, may be combined to arrive at yet other embodiments for practicing the technology described in the present disclosure. Thus, the disclosure is not limited to the examples and designs described herein but is to be accorded the broadest scope consistent with the principles and novel features disclosed herein.

The flowcharts and block diagrams in the figures illustrate examples of the architecture, functionality, and operation of possible implementations of systems, methods, and devices according to various embodiments. It should be noted that, in some alternative implementations, the functions noted in blocks may occur out of the order noted in the figures. For example, two blocks shown in succession may, in fact, be executed substantially concurrently, or the blocks may sometimes be executed in the reverse order, depending upon the functionality involved. Likewise, additional steps may be included in such methods, and certain steps may be omitted or combined, in methods consistent with various embodiments.

It is understood that the described embodiments are not mutually exclusive, and elements, components, materials, or steps described in connection with one example embodiment may be combined with, or eliminated from, other embodiments in suitable ways to accomplish desired design objectives.

Reference herein to “some embodiments” or “some exemplary embodiments” means that a particular feature, structure, or characteristic described in connection with the embodiment can be included in at least one embodiment. The appearance of the phrases “one embodiment” “some embodiments” or “another embodiment” in various places in the present disclosure do not all necessarily refer to the same embodiment, nor are separate or alternative embodiments necessarily mutually exclusive of other embodiments.

Additionally, the articles “a” and “an” as used in the present disclosure and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

Although the elements in the following method claims, if any, are recited in a particular sequence, unless the claim recitations otherwise imply a particular sequence for implementing some or all of those elements, those elements are not necessarily intended to be limited to being implemented in that particular sequence.

It is appreciated that certain features of the present disclosure, which are, for clarity, described in the context of separate embodiments, may also be provided in combination in a single embodiment. Conversely, various features of the specification, which are, for brevity, described in the context of a single embodiment, may also be provided separately or in any suitable subcombination or as suitable in any other described embodiment of the specification. Certain features described in the context of various embodiments are not essential features of those embodiments, unless noted as such.

It will be further understood that various modifications, alternatives, and variations in the details, materials, and arrangements of the parts which have been described and illustrated in order to explain the nature of described embodiments may be made by those skilled in the art without departing from the scope. Accordingly, the following claims embrace all such alternatives, modifications, and variations that fall within the terms of the claims.
Clause 1. A first user equipment (UE) for sidelink beam maintenance in a sidelink communication, the first UE comprising:
   a memory storing an instruction; and
   a processor configured to execute the instruction stored in the memory to:
   obtain resource reservation information and future location information of the first UE, the future location information of the first UE including an estimated first location of the first UE at a first time later than a current time;
   transmit, to a second UE, the resource reservation information and the future location information of the first UE;
   receive, from the second UE, a signal including future location information of the second UE, the future location information of the second UE including an estimated second location of the second UE at the first time; and determine, based on the future location information of the second UE, one or more beams for transmission from the first UE.
Clause 2. The first UE of clause 1, wherein the one or more beams for transmission from the first UE are determined within a time period, the time period including the first time.
Clause 3. The first UE of clause 1, wherein the processor is further configured to execute the instruction stored in the memory to:
   perform beam training on one or more beams of a plurality of beams before determining the one or more beams for transmission from the first UE.
Clause 4. The first UE of clause 1, wherein the processor is further configured to execute the instruction stored in the memory to:
   transmit, to the second UE, a packet using the determined one or more beams.
Clause 5. The first UE of clause 4, wherein the future location information of the first UE is a first future location information of the first UE, and wherein the packet includes second future location information of the first UE, the second future location information of the first UE including an estimated third location of the first UE at a second time later than the first time, the estimated third location being the same as, or different from, the estimated first location or the estimated second location.
Clause 6. The first UE of clause 1, wherein in obtaining the resource reservation information and the future location information of the first UE, the processor is further configured to execute the instruction stored in the memory to:
   determine the estimated first location of the first UE at the first time based on at least one of: a current location of the first UE, a speed of the first UE, a heading of the first UE, or a planned trajectory of the first UE.
Clause 7. The first UE of clause 1, wherein the resource reservation information and the future location information of the first UE are transmitted via at least one of sidelink control information (SCI) at physical layer, media access control (MAC) control element (CE) at MAC layer, or higher layer information.
Clause 8. The first UE of clause 1, wherein the resource reservation information and the future location information of the first UE are transmitted using FR1.
Clause 9. The first UE of clause 1, wherein the resource reservation information and the future location information of the first UE are transmitted using a millimeter wave frequency band.
Clause 10. The first UE of clause 1, wherein the future location information of the second UE is transmitted via at least one of SCI at physical layer, MAC CE at MAC layer, or higher layer information.
Clause 11. The first UE of clause 1, wherein the resource reservation information and the future location information of the first UE are included in a packet transmitted from the first UE to the second UE.
Clause 12. The first UE of clause 1, wherein the future location information of the first UE is indicated as an identification (ID) of a zone of a plurality of zones in two-dimension or three-dimension, the plurality of zones being configured or pre-configured.
Clause 13. The first UE of clause 1, wherein the future location information of the first UE is indicated as two or more IDs of a zone of a plurality of zones in two-dimension or three-dimension, the two or more IDs of the zone including a sub-zone ID that is used for beamforming, the plurality of zones being configured or pre-configured.
Clause 14. The first UE of clause 1, wherein the future location information of the second UE is indicated as an ID of a zone of a plurality of zones in two-dimension or three-dimension, the plurality of zones being configured or pre-configured.
Clause 15. The first UE of clause 1, wherein the future location information of the second UE is indicated as two or more IDs of a zone of a plurality of zones in two-dimension or three-dimension, the two or more IDs of the zone including a sub-zone ID that is used for beamforming, the plurality of zones being configured or pre-configured.
Clause 16. The first UE of clause 1, wherein the processor is further configured to execute the instruction stored in the memory to receive a trigger signal via a sidelink transmission, and wherein determining the one or more beams for transmission from the first UE is based on the trigger signal.
Clause 17. The first UE of clause 1, wherein the signal received from the second UE comprises a hybrid automatic repeat request (HARQ) acknowledgement message.
Clause 18. A second user equipment (UE) for sidelink beam maintenance in a sidelink communication, the second UE comprising:
   a memory storing an instruction; and
   a processor configured to execute the instruction stored in the memory to:
   receive, from a first UE, resource reservation information and future location information of the first UE, the future location information of the first UE including an estimated first location of the first UE at a first time later than a current time;
   transmit, to the first UE, a signal in response to reception of the resource reservation information and the future location information of the first UE, the signal including future location information of the second UE, the future location information of the second UE including an estimated second location of the second UE at the first time; and
   determine, based on the future location information of the first UE, one or more beams for reception by the second UE.
Clause 19. The second UE of clause 18, wherein the one or more beams for reception by the second UE are determined within a time period, the time period including the first time.
Clause 20. The second UE of clause 18, wherein the processor is further configured to execute the instruction stored in the memory to:
   perform beam training on one or more beams of a plurality of beams before determining the one or more beams for reception by the second UE.
Clause 21. The second UE of clause 18, wherein the processor is further configured to execute the instruction stored in the memory to:
   receive, from the first UE, a packet using the determined one or more beams.
Clause 22. The second UE of clause 21, wherein the future location information of the first UE is a first future location information of the first UE, and wherein the packet includes second future location information of the first UE, the second future location information of the first UE including an estimated third location of the first UE at a second time later than the first time, the estimated third location being the same as, or different from, the estimated first location or the estimated second location.
Clause 23. The second UE of clause 18, wherein the processor is further configured to execute the instruction stored in the memory to:
   determine the estimated second location of the second UE at the first time based on at least one of: a current location of the second UE, a speed of the second UE, a heading of the second UE, or a planned trajectory of the second UE.
Clause 24. The second UE of clause 18, wherein the future location information of the second UE is transmitted via at least one of sidelink control information (SCI) at physical layer, media access control (MAC) control element (CE) at MAC layer, or higher layer information.
Clause 25. The second UE of clause 18, wherein the future location information of the second UE is transmitted using an FR1.
Clause 26. The second UE of clause 18, wherein the future location information of the second UE is transmitted using a millimeter wave frequency band.
Clause 27. The second UE of clause 18, wherein the resource reservation information and the future location information of the first UE are included in a packet transmitted from the first UE to the second UE.
Clause 28. The second UE of clause 18, wherein the future location information of the first UE is indicated as an identification (ID) of a zone of a plurality of zones in two-dimension or three-dimension, the plurality of zones being configured or pre-configured.
Clause 29. The second UE of clause 18, wherein the future location information of the first UE is indicated as two or more IDs of a zone of a plurality of zones in two-dimension or three-dimension, the two or more IDs of the zone including a sub-zone ID that is used for beamforming, the plurality of zones being configured or pre-configured.
Clause 30. The second UE of clause 18, wherein the future location information of the second UE is indicated as an ID of a zone of a plurality of zones in two-dimension or three-dimension, the plurality of zones being configured or pre-configured.
Clause 31. The second UE of clause 18, wherein the future location information of the second UE is indicated as two or more IDs of a zone of a plurality of zones in two-dimension or three-dimension, the two or more IDs of the zone including a sub-zone ID that is used for beamforming, the plurality of zones being configured or pre-configured.
Clause 32. A method for sidelink beam maintenance in a sidelink communication, the method comprising:
   obtaining, by a first user equipment (UE), resource reservation information and future location information of the first UE, the future location information of the first UE including an estimated first location of the first UE at a first time later than a current time;
   transmitting, to a second UE, the resource reservation information and the future location information of the first UE;
   receiving, from the second UE, a signal including future location information of the second UE, the future location information of the second UE including an estimated second location of the second UE at the first time; and
   determining, based on the future location information of the second UE, one or more beams for transmission from the first UE.
Clause 33. The method of clause 32, wherein the one or more beams for transmission from the first UE are determined within a time period, the time period including the first time.
Clause 34. The method of clause 32, further comprising: performing beam training on one or more beams of a plurality of beams before determining the one or more beams for transmission from the first UE.
Clause 35. The method of clause 32, further comprising: transmitting, to the second UE, a packet using the determined one or more beams.
Clause 36. The method of clause 35, wherein the future location information of the first UE is a first future location information of the first UE, and wherein the packet includes second future location information of the first UE, the second future location information of the first UE including an estimated third location of the first UE at a second time later than the first time, the estimated third location being the same as, or different from, the estimated first location or the estimated second location.
Clause 37. The method of clause 32, wherein obtaining the resource reservation information and the future location information of the first UE further comprises:
   determining the estimated first location of the first UE at the first time based on at least one of: a current location of the first UE, a speed of the first UE, a heading of the first UE, or a planned trajectory of the first UE.
Clause 38. The method of clause 32, wherein the resource reservation information and the future location information of the first UE are transmitted via at least one of sidelink control information (SCI) at physical layer, media access control (MAC) control element (CE) at MAC layer, or higher layer information.
Clause 39. The method of clause 32, wherein the resource reservation information and the future location information of the first UE are transmitted using FR1.
Clause 40. The method of clause 32, wherein the resource reservation information and the future location information of the first UE are transmitted using a millimeter wave frequency band.
Clause 41. The method of clause 32, wherein the future location information of the second UE is transmitted via at least one of SCI at physical layer, MAC CE at MAC layer, or higher layer information.
Clause 42. The method of clause 32, wherein the resource reservation information and the future location information of the first UE are included in a packet transmitted from the first UE to the second UE.
Clause 43. The method of clause 32, wherein the future location information of the first UE is indicated as an identification (ID) of a zone of a plurality of zones in two-dimension or three-dimension, the plurality of zones being configured or pre-configured.
Clause 44. The method of clause 32, wherein the future location information of the first UE is indicated as two or more IDs of a zone of a plurality of zones in two-dimension or three-dimension, the two or more IDs of the zone including a sub-zone ID that is used for beamforming, the plurality of zones being configured or pre-configured.
Clause 45. The method of clause 32, wherein the future location information of the second UE is indicated as an ID of a zone of a plurality of zones in two-dimension or three-dimension, the plurality of zones being configured or pre-configured.
Clause 46. The method of clause 32, wherein the future location information of the second UE is indicated as two or more IDs of a zone of a plurality of zones in two-dimension or three-dimension, the two or more IDs of the zone including a sub-zone ID that is used for beamforming, the plurality of zones being configured or pre-configured.
Clause 47. The method of clause 32, further comprising receiving a trigger signal via a sidelink transmission, wherein determining the one or more beams for transmission from the first UE is based on the trigger signal.
Clause 48. The method of clause 32, wherein the signal received from the second UE comprises a hybrid automatic repeat request (HARQ) acknowledgement message.
Clause 49. A method for sidelink beam maintenance in a sidelink communication, the method comprising:
   receiving, by a second user equipment (UE), from a first UE, resource reservation information and future location information of the first UE, the future location information of the first UE including an estimated first location of the first UE at a first time later than a current time;
   transmitting, to the first UE, a signal in response to reception of the resource reservation information and the future location information of the first UE, the signal including future location information of the second UE, the future location information of the second UE including an estimated second location of the second UE at the first time; and
   determining, based on the future location information of the first UE, one or more beams for reception by the second UE.
Clause 50. The method of clause 49, wherein the one or more beams for reception by the second UE are determined within a time period, the time period including the first time.
Clause 51. The method of clause 49, further comprising: performing beam training on one or more beams of a plurality of beams before determining the one or more beams for reception by the second UE.
Clause 52. The method of clause 49, further comprising: receiving, from the first UE, a packet using the determined one or more beams.
Clause 53. The method of clause 52, wherein the future location information of the first UE is a first future location information of the first UE, and wherein the packet includes second future location information of the first UE, the second future location information of the first UE including an estimated third location of the first UE at a second time later than the first time, the estimated third location being the same as, or different from, the estimated first location or the estimated second location.
Clause 54. The method of clause 49, further comprising: determining the estimated second location of the second UE at the first time based on at least one of: a current location of the second UE, a speed of the second UE, a heading of the second UE, or a planned trajectory of the second UE.
Clause 55. The method of clause 49, wherein the future location information of the second UE is transmitted via at least one of sidelink control information (SCI) at physical layer, media access control (MAC) control element (CE) at MAC layer, or higher layer information.
Clause 56. The method of clause 49, wherein the future location information of the second UE is transmitted using an FR1.
Clause 57. The method of clause 49, wherein the future location information of the second UE is transmitted using a millimeter wave frequency band.
Clause 58. The method of clause 49, wherein the resource reservation information and the future location information of the first UE are included in a packet transmitted from the first UE to the second UE.
Clause 59. The method of clause 49, wherein the future location information of the first UE is indicated as an identification (ID) of a zone of a plurality of zones in two-dimension or three-dimension, the plurality of zones being configured or pre-configured.
Clause 60. The method of clause 49, wherein the future location information of the first UE is indicated as two or more IDs of a zone of a plurality of zones in two-dimension or three-dimension, the two or more IDs of the zone including a sub-zone ID that is used for beamforming, the plurality of zones being configured or pre-configured.
Clause 61. The method of clause 49, wherein the future location information of the second UE is indicated as an ID of a zone of a plurality of zones in two-dimension or three-dimension, the plurality of zones being configured or pre-configured.
Clause 62. The method of clause 49, wherein the future location information of the second UE is indicated as two or more IDs of a zone of a plurality of zones in two-dimension or three-dimension, the two or more IDs of the zone including a sub-zone ID that is used for beamforming, the plurality of zones being configured or pre-configured.
Clause 63. A non-transitory computer-readable medium storing instructions that are executable by one or more processors of a first user equipment (UE) in a sidelink communication network, to perform a method, the method comprising:
   obtaining resource reservation information and future location information of the first UE, the future location information of the first UE including an estimated first location of the first UE at a first time later than a current time;
   transmitting, to a second UE, the resource reservation information and the future location information of the first UE;
   receiving, from the second UE, a signal including future location information of the second UE, the future location information of the second UE including an estimated second location of the second UE at the first time; and determining, based on the future location information of the second UE, one or more beams for transmission from the first UE.
Clause 64. A non-transitory computer-readable medium storing instructions that are executable by one or more processors of a second user equipment (UE) in a sidelink communication, to perform a method, the method comprising: receiving, from a first UE, resource reservation information and future location information of the first UE, the future location information of the first UE including an estimated first location of the first UE at a first time later than a current time;
   transmitting, to the first UE, a signal in response to reception of the resource reservation information and the future location information of the first UE, the signal including future location information of the second UE, the future location information of the second UE including an estimated second location of the second UE at the first time; and
   determining, based on the future location information of the first UE, one or more beams for reception by the second UE.

1. A first user equipment (UE) for sidelink beam maintenance in a sidelink communication, the first UE comprising:
a memory storing an instruction; and
a processor configured to execute the instruction stored in the memory to:
obtain resource reservation information and future location information of the first UE, the future location information of the first UE including an estimated first location of the first UE at a first time later than a current time;
transmit, to a second UE, the resource reservation information and the future location information of the first UE;
receive, from the second UE, a signal including future location information of the second UE, the future location information of the second UE including an estimated second location of the second UE at the first time; and
determine, based on the future location information of the second UE, one or more beams for transmission from the first UE.

2. The first UE of claim 1, wherein the one or more beams for transmission from the first UE are determined within a time period, the time period including the first time.

3. The first UE of claim 1, wherein the processor is further configured to execute the instruction stored in the memory to:
perform beam training on one or more beams of a plurality of beams before determining the one or more beams for transmission from the first UE.

4. The first UE of claim 1, wherein the processor is further configured to execute the instruction stored in the memory to:
transmit, to the second UE, a packet using the determined one or more beams.

5. The first UE of claim 4, wherein the future location information of the first UE is a first future location information of the first UE, and wherein the packet includes second future location information of the first UE, the second future location information of the first UE including an estimated third location of the first UE at a second time later than the first time, the estimated third location being the same as, or different from, the estimated first location or the estimated second location.

6. The first UE of claim 1, wherein in obtaining the resource reservation information and the future location information of the first UE, the processor is further configured to execute the instruction stored in the memory to:
determine the estimated first location of the first UE at the first time based on at least one of: a current location of the first UE, a speed of the first UE, a heading of the first UE, or a planned trajectory of the first UE.

7. The first UE of claim 1, wherein the resource reservation information and the future location information of the first UE are transmitted via at least one of sidelink control information (SCI) at physical layer, media access control (MAC) control element (CE) at MAC layer, or higher layer information.

8. The first UE of claim 1, wherein the resource reservation information and the future location information of the first UE are transmitted using FR1.

9. The first UE of claim 1, wherein the resource reservation information and the future location information of the first UE are transmitted using a millimeter wave frequency band.

10. The first UE of claim 1, wherein the future location information of the second UE is transmitted via at least one of SCI at physical layer, MAC CE at MAC layer, or higher layer information.

11. The first UE of claim 1, wherein the resource reservation information and the future location information of the first UE are included in a packet transmitted from the first UE to the second UE.

12. The first UE of claim 1, wherein the future location information of the first UE is indicated as an identification (ID) of a zone of a plurality of zones in two-dimension or three-dimension, the plurality of zones being configured or pre-configured.

13. The first UE of claim 1, wherein the future location information of the first UE is indicated as two or more IDs of a zone of a plurality of zones in two-dimension or three-dimension, the two or more IDs of the zone including a sub-zone ID that is used for beamforming, the plurality of zones being configured or pre-configured.

14. The first UE of claim 1, wherein the future location information of the second UE is indicated as an ID of a zone of a plurality of zones in two-dimension or three-dimension, the plurality of zones being configured or pre-configured.

15. The first UE of claim 1, wherein the future location information of the second UE is indicated as two or more IDs of a zone of a plurality of zones in two-dimension or three-dimension, the two or more IDs of the zone including a sub-zone ID that is used for beamforming, the plurality of zones being configured or pre-configured.

16. The first UE of claim 1, wherein the processor is further configured to execute the instruction stored in the memory to receive a trigger signal via a sidelink transmission, and wherein determining the one or more beams for transmission from the first UE is based on the trigger signal.

17. The first UE of claim 1, wherein the signal received from the second UE comprises a hybrid automatic repeat request (HARQ) acknowledgement message.

18. A second user equipment (UE) for sidelink beam maintenance in a sidelink communication, the second UE comprising:
a memory storing an instruction; and
a processor configured to execute the instruction stored in the memory to:
receive, from a first UE, resource reservation information and future location information of the first UE, the future location information of the first UE including an estimated first location of the first UE at a first time later than a current time;
transmit, to the first UE, a signal in response to reception of the resource reservation information and the future location information of the first UE, the signal including future location information of the second UE, the future location information of the second UE including an estimated second location of the second UE at the first time; and
determine, based on the future location information of the first UE, one or more beams for reception by the second UE.

19. The second UE of claim 18, wherein the one or more beams for reception by the second UE are determined within a time period, the time period including the first time.

20. A method for sidelink beam maintenance in a sidelink communication, the method comprising:
obtaining, by a first user equipment (UE), resource reservation information and future location information of the first UE, the future location information of the first UE including an estimated first location of the first UE at a first time later than a current time;
transmitting, to a second UE, the resource reservation information and the future location information of the first UE;
receiving, from the second UE, a signal including future location information of the second UE, the future location information of the second UE including an estimated second location of the second UE at the first time; and
determining, based on the future location information of the second UE, one or more beams for transmission from the first UE.
